(19) United States
(12) Patent Application Publication
(10) Pub. No.: US 2009/0252317 A1
(43) Pub. Date: Oct. 8, 2009

(54) Method of managing a telecommunications system for adaptive serial ringing and program product therefor

(75) Inventor: Farrokh Mohammadzadeh Kouchri, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 12/080,539

(22) Filed: Apr. 3, 2008

(51) Int. Cl. H04M 3/42

(52) U.S. Cl. 379/211.03

(57) ABSTRACT

A method of managing communications in a communications network and a program product therefore. Users provide lists of expected future locations, e.g., Serial Ringing (SR) lists. As each call traverses a user's SR-list to contact a respective user, the user's current location (i.e., the endpoint at which a call is answered) is noted and the list is automatically altered (e.g., reordered or timeouts shortened) to shorten the time between receiving an incoming call at the system and ringing the answering endpoint. Thereafter, the altered SR-list is used to locate the respective user.

### BACKGROUND OF THE INVENTION

1. Field of the Invention

The present invention is related to telecommunications systems and networks and more particularly, to managing calls in public and/or private telecommunications networks.

1. Background Description

Serial Ringing (SR) has proven to be a useful feature in modern private telecommunications systems such as the HiPath 8000 from Siemens Communications Inc. When a user expects to be away from his/her desk, for example, the user can setup an SR-list of numbers in expected locations, e.g., the lab, a co-worker's extension, home and cell phone. With the SR feature activated, when calls to the user (called party) arrive at the system, the system rings each location in the order listed until someone answers.

Currently, the system sequentially forwards each incoming call in the order presented in the SR-list. The forwarded call rings for a selected number of rings or a certain amount of time at each location along the way. Each caller has to wait for a time out at each listed location, e.g., for 4 rings (or 1 minute for each location), until the user answers. Even with calls placed to the user one right after the other, to reach the same location, each call traverses the SR-list in the same order, ringing each location for the same time until the user finally answers.

For example, the user may be at the third SR-list entry location with the SR-feature activated. Each time someone (a calling party or caller) calls the user, the system rings at the first SR-entry a selected number of rings (i.e., until a time out occurs); then, rings at the second SR-entry until a time out; and, finally, rings the third SR-entry where the user answers. As long the user is at this third listed location, any caller must wait for time-outs at the first and second locations before reaching the user at the third. The delay from pausing at each intermediate location unnecessarily wastes the caller's time and telecom system resources as well as. Further, with too many intermediate locations callers may become frustrated and hang up or transfer to voice mail before reaching the user, again wasting time and resources as well as frustrating the purpose of serial calling.

Thus, there is a need for reducing the delay in connecting calls to users through serial ringing.

### SUMMARY OF THE INVENTION

It is a purpose of the invention to improve communications system efficiency;

It is another purpose of the invention to quickly connect callers with users that are away from their normal network endpoints;

The present invention relates to a method of managing communications in a communications network and a program product therefore. Users provide lists of expected future locations, e.g., Serial Ringing (SR) lists. As each call traverses a user's SR-list to contact a respective user, the user's current location (i.e., the endpoint at which a call is answered) is noted and the list is automatically altered (e.g., reordered or timeouts shortened) to shorten the time between receiving an incoming call at the system and ringing the answering endpoint. Thereafter, the altered SR-list is used to locate the respective user.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a communications system administering Serial Ringing (SR) according to a preferred embodiment of the present invention;

FIG. 2 shows an example of serial ringing for an in-network call.

### DESCRIPTION OF PREFERRED EMBODIMENTS

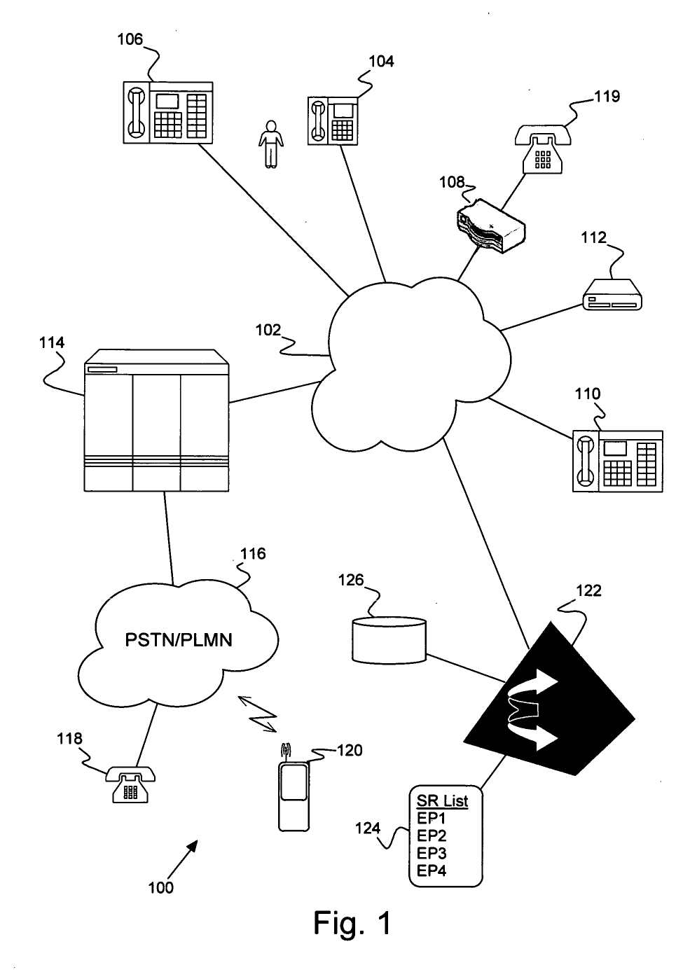

Turning now to the drawings and more particularly, FIG. 1 shows an example of a communications system 100 including a digital call capable network 102, e.g., an Internet Protocol (IP) based network capable of Voice over IP (VoIP) communications network (e.g., a session initiation protocol (SIP) network), administering Serial Ringing (SR) according to a preferred embodiment of the present invention. The system 100 includes with digital telephony devices (e.g., SIP devices or VoIP phones) and Multimedia Terminal Adapters (MTA) at End Points (EP) 104, 106, 108, 110 at private network locations, e.g., keysets at the EPs 104, 106, 110. Since an attached network device defines an EP, each EP and a device(s) at the EP are referred to herein interchangeably.

A suitable proxy server 112 provides a router function to private network 102. A gateway 114, e.g., a state of the art media gateway controller such as a SIP enabled private branch exchange (PBX), connects the network 102 externally. Typically, for example, the gateway 114 connects to a public switched telephone network/public land mobile network (PSTN/PLMN) 116 supporting typical connected telephones, e.g., land line telephones 118 and/or cell phones 120. The MTA 108 may be a SIP-MTA, connecting to the IP-network 102 at one side and one or more regular analog phones 119. One or more softswitch(s) 122, acting alone or in cooperation with each other, may perform network tasks e.g., routing, subscriber-features, administering the network, creating Call Detail Records (CDR), and acting as a Media Gateway Controller (MGC) remotely located in a data center.

Moreover, the softswitch(s) 122 manages calls to/from keysets 104, 106, 110 and telephones 119 (at MTA endpoint 108) from/to each other or through the gateway 114, e.g., to land line telephone 118. SR lists 124 for each user may be stored, e.g., in storage 126 at softswitch 122. Each SR list 124 includes a contact number for each of a number, e.g., six (6), of expected locations in an order selected by the respective user, e.g., the order in which the user expects to visit those locations or based on the likelihood that the user will be present in any one location. It should be noted that, although described herein with reference to a private network and more particularly to a private network supported by a SIP PBX, the present invention has application to any suitable communications system or network, private or public.

According to a preferred embodiment of the present invention, the preferred system 100 has an enhanced serial ringing feature, e.g., in software in softswitch 122, such that the system 100 adapts itself to the most recent user location. In particular, after ringing through and connecting with a user (called party) that has activated the SR feature, the softswitch 122 shortens connection time for subsequent calls. This adaptive serial ringing feature may behave subject to user subscription and setup. Further, this adapted serial ringing may temporarily change the ringing order or ringing time with the SR-list reverting to its original order or ring times when, for example, the softswitch 122 detects any activity at the user's first original EP.

In one preferred embodiment, the softswitch 122 notes the user's current location and reorders the SR-list to reduce system resource usage. Thus, the softswitch 122 may place the SR-entry at which the system last reached the user, i.e., the user's current location, at the top of the reordered list. The softswitch 122 may just reorder the list by moving the single entry for the last location to the top of the list. Alternately, the system may move all of the entries listed before that last location to the end of the list, i.e., rotate the listed entries, such that any listed entries after the current location ring before moved entries.

In another preferred embodiment, the softswitch 122 shortens the ringing time at each intervening EP, i.e., the EP entries listed before that last location ring twice. Thus, subsequent forwarded calls pause at each intervening EP briefly on the way to the last answering location. Thereafter, once the system detects activity in the user's home location or in intervening locations, the system may reset/restore the original ring time. Such activity may include, for example, checking voice mail from an intervening end point or at the user's home location. Answering from one of those intervening locations may also triggers restoring the original order or resetting ringing.

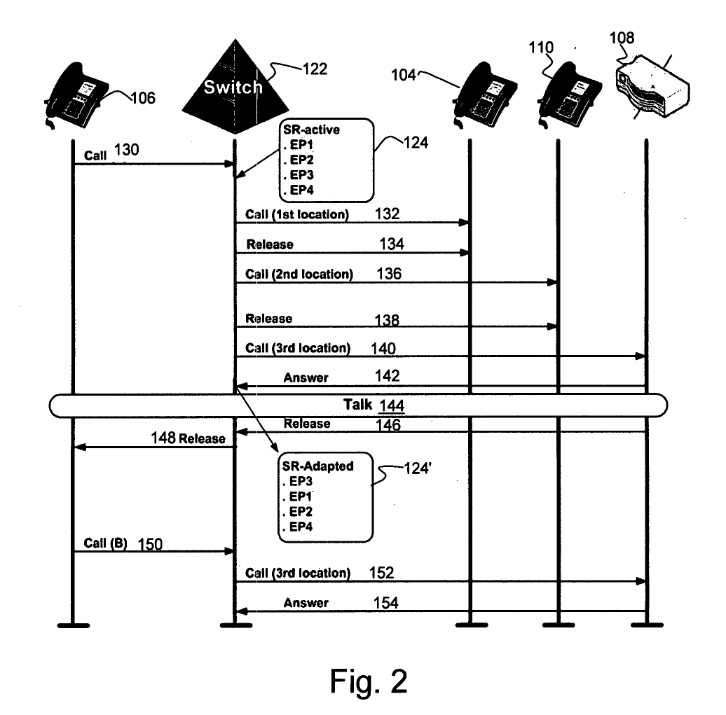

FIG. 2 shows an example of serial ringing for an in-network call in the system 100 of FIG. 1. In this example, the user normally associated with digital telephone 104 has activated his/her serial ringing feature. Also, the user has setup the SR-list 124 with 4 entries in this example. So, the first call, originating 130 from another endpoint (e.g., 106) or from an external device (e.g., 118 or 120 through gateway 114) to the user (called party), to digital telephone 104 is forwarded normally. The softswitch 122 rings the call 132 at the first listed location 104. If the user does not answer at the first location 104 a timeout occurs in the softswitch 122 for the call processing task. The softswitch 122 sends a release message 134 to the first listed location 104 and rings 136 the second listed location, e.g., 110. If the user does not answer at the second listed location 110 another timeout occurs. The softswitch 122 sends another release message 138 to the second listed location 110 and the call rings 140 at the third listed location, e.g., 108. When the user answers, an answer message 142 is sent from the answering location 108. When the softswitch 122 receives the answer message 142, the softswitch 122 adapts the SR list 124′ to shorten the serial ring time for the next and subsequent call. In this example, the softswitch 122 places the third, answering location 108 (identified as the user's current location) at the top of the list 124′. When the user completes the call 144, the endpoint device 108 sends a release message 146 to the softswitch 122. The switch 122 sends a release message 148 to the calling endpoint 106 or the gateway 114.

Thereafter, when the softswitch 122 receives the next call 150 to the user, since the SR list 124′ was adapted based on the most recent call answered, the softswitch 122 forwards that call 152 directly to that answering location 108, where the user answers 154. If the user fails to answer at that location 106, the switch continues forwarding to listed locations 104, 110 in the reordered list 124′ with changes in user location noted and the list adjusted.

Advantageously, the present invention provides adaptive serial ringing that learns where users currently can be reached and temporarily changes the SR-list to shorten the time to the called party, e.g., changing the SR order or shortening the ringing time for intervening EPs. Thus, delay from pausing at each intermediate or intervening location is eliminated or dramatically reduced to avoid unnecessarily wasting the caller's time and telecom system resources and frustrating callers.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of managing communications in a communications network with a plurality of endpoints, said method comprising the steps of:
a) providing a list of endpoints, said list being associated with a user associated with one of said plurality of endpoints;
b) receiving a call to said one;
c) ringing listed said endpoints in a listed order until said call is answered at a listed endpoint, the listed endpoint being the answering endpoint;
d) automatically altering the list to shorten the time between receiving a call and ringing said answering endpoint; and after answering said call at said answering endpoint
e) returning to step (b) for a next call to said one.

2. A method of managing communications as in claim 1, wherein the list includes a selectable timeout at each said listed endpoint and the step (d) of automatically altering the list comprises shortening the timeout at said one and at said listed endpoints between said one and said answering endpoint.

3. A method of managing communications as in claim 2, wherein said selectable timeout is a number of rings at each listed endpoint and shortening the timeout comprises reducing the number of rings.

4. A method of managing communications as in claim 2, wherein whenever the said answering endpoint is listed before a last said answering endpoint, the step (d) further comprises automatically increasing the selectable timeout at said listed endpoints listed between said answering endpoint and said last answering endpoint.

5. A method of managing communications as in claim 1, wherein the step (d) of automatically altering said list comprises automatically reordering said list, the answering endpoint being placed at the beginning of said listed order and using the reordered list in step (c) for subsequent calls.

6. A method of managing communications as in claim 1, wherein the list is a Serial Ringing list (SR-list) and the ringing step (c) comprises:
i) selecting a first listed endpoint from said SR-list;
ii) sending a ringing message to a telecommunications device at the selected endpoint;
iii) waiting for an answer message from said selected endpoint within a selected period of time; and after the selected period of time
iv) selecting a next listed endpoint from said SR-list and returning to step (ii).

7. A method of managing communications as in claim 6, wherein automatically altering the list comprises shortening the selected period of time.

8. A method of managing communications as in claim 7, wherein shortening the selected period of time comprises reducing the number of rings at said one and at said listed endpoints between said one and said answering endpoint.

9. A method of managing communications as in claim 6, wherein automatically altering the list-comprises reordering said list, the answering endpoint being placed at the beginning of said listed order and selected in step (i) for subsequent calls.

10. A method of managing communications in a communications network with a plurality of endpoints, said method comprising the steps of:
a) providing a Serial Ringing list (SR-list) of endpoints, said SR-list being associated with a user associated with one of said plurality of endpoints;
b) receiving a call to said one;
c) locating said user at a listed endpoint;
d) ringing said listed endpoint;
e) automatically reordering said SR-list whenever said listed endpoint is listed after another endpoint in said SR-list, said listed endpoint being listed first in the reordered SR-list; and after answering said call at said listed endpoint
f) returning to step (b) for a next call to said one.

11. A method of managing communications as in claim 10, wherein the locating step (c) comprises:
i) selecting a first listed endpoint from said SR-list;
ii) sending a ringing message to a telecommunications device at the selected endpoint;
iii) waiting for an answer message from said listed endpoint within a selected period of time; and after the selected period of time
iv) selecting a next listed endpoint from said SR-list and returning to step (ii), said user being located at said listed endpoint where said call is answered in step (iii).

12. A method of managing communications in a communications network with a plurality of endpoints, said method comprising the steps of:
a) providing a list of endpoints, said list being associated with a user associated with one of said plurality of endpoints;
b) receiving a call to said one;
c) ringing listed said endpoints in a listed order for a selected number of rings at each listed endpoint until said call is answered, the call being answered at an answering endpoint;
d) automatically reducing the number of rings in listed endpoints listed before said answering endpoint whenever said answering endpoint is listed after a last said answering endpoint; and after answering said call at said answering endpoint
e) returning to step (b) for a next call to said one.

13. A method of managing communications as in claim 12, wherein the list includes a selectable timeout at each said listed endpoint and the step (d) of automatically reducing the number of rings comprises shortening the timeout at said one and at said listed endpoints listed between said one and said answering endpoint.

14. A method of managing communications as in claim 12, wherein the ringing step (c) comprises:
i) selecting a first listed endpoint from said SR-list;
ii) sending a ringing message to a telecommunications device at the selected endpoint;
iii) waiting for an answer message from said selected endpoint within a selected period of time; and after the selected period of time
iv) selecting a next listed endpoint from said SR-list and returning to step (ii).

15. A method of managing communications as in claim 14, wherein automatically reducing the number of rings comprises shortening the selected period of time.

16. A method of managing communications as in claim 12, wherein whenever the said answering endpoint is listed before a last said answering endpoint, the step (d) further comprises automatically increasing the number of rings at said listed endpoints listed between said answering endpoint and said last answering endpoint.

17. A computer program product for managing a Serial Ringing (SR) in a communications network with a plurality of endpoints, said computer program product comprising a computer usable medium having computer readable program code stored thereon, said computer readable program code comprising:
computer readable program code means for maintaining SR-lists of endpoints and associating each SR-list with a user of one of said plurality of endpoints;
computer readable program code means for ringing listed said endpoints responsive to a call to a respective said one, said endpoints being rung in a listed order until said call is answered at an answering endpoint; and
computer readable program code means for automatically altering the SR-list to shorten the time between receiving a call and ringing a respective said answering endpoint, the altered SR-list being used for subsequent calls.

18. A computer program product as in claim 17, wherein the computer readable program code means for automatically altering the SR-list comprises computer readable program code means for selectively changing a timeout at said listed endpoints, changing said timeout changing a number of endpoint rings.

19. A computer program product as in claim 17, wherein the computer readable program code means for automatically altering the SR-list comprises computer readable program code means for automatically reordering said list.
